(19) United States
(12) Patent Application Publication
(10) Pub. No.: US 2007/0206115 A1
(43) Pub. Date: Sep. 6, 2007

(54) CONTAINER AND RETRACTABLE SUPPORT FRAME STRUCTURE ARRANGEMENT

(75) Inventor: Po-Cho Kuo, TAIPEI (TW)

Correspondence Address: SEVEN STARS ELECTRONICS TAIWAN LTD., P.O. BOX 108-00403, TAIPEI, TW

(73) Assignee: SEVEN STARS ELECTRONICS TAIWAN LTD., Hsin Tien City (TW)

(21) Appl. No.: 11/308,077

(22) Filed: Mar. 6, 2006

(51) Int. Cl. H04N 5/225

(52) U.S. Cl. 348/373

(57) ABSTRACT

Disclosed is container and retractable support frame structure arrangement comprising a container, and a retractable support frame structure mounted in said container and adapted to hold a camera and to support said container above a floor surface, said retractable support frame structure comprising a plurality of sleeves arranged in parallel, positioning means adapted to secure said sleeves to said container, a camera platform provided above said sleeves for holding a camera, and a plurality of extension foot members respectively mounted in said sleeves and movable in and out of said sleeves and a bottom side of said container between an extended position and a retracted position.

### BACKGROUND OF THE INVENTION

1. Field of the Invention

The present invention relates a container and retractable support frame structure arrangement in which positioning means is used to secure a retractable support frame structure to a container, for example, a baggage, enabling the retractable support frame structure to support the container above a floor surface and to hold a camera for taking pictures (video images).

2. Description of the Related Art

Following the prosperity of the society, many countries employ the system of 5-day-on 2-day-off. Nowadays, people do care more about recreational activities. Many companies encourage their employees to participate in outdoors activities in after duty hours. During the weekend, people may visit different exhibitions or shows, or take a weekend trip, and enjoy themselves without a worry or care in the world. When travelling, people may carry many clothes and personal items in bags and/or luggage, and may also carry a camera or video camera for taking pictures or video images. Furthermore, people may also carry a tripod to support a camera or video camera on a floor or ground surface for taking pictures or video images. By means of the support of a tripod, the user can adjust the aperture ring, the shutter-speed, or the focus conveniently. Furthermore, the use of a tripod to support a camera eliminates vibration when taking a picture with the camera. However, it is heavy to carry a tripod when taking a trip. In order to save storage space, a retractable tripod may be used. However, a retractable tripod still occupies much storage space in a bag or luggage. Furthermore, the user must take the tripod out of the bag before photographing, and then replace the tripod inside the bag after photographing. In addition, if a person carries a bag in an environment where the ground is dirty or covered with water and wishes to take a picture at this time, he or she must keep carrying the bag to prevent contamination.

### SUMMARY OF THE INVENTION

The present invention has been accomplished under the circumstances in view. It is the main object of the present invention to provide a container and retractable support frame structure arrangement, which incorporates a retractable support frame structure into a baggage, travel bag, suitcase, or any of a variety of mobile containers so that the user can directly use the baggage, travel bag, or suitcase to hold a camera on a floor or ground surface to take pictures (or video images). To achieve this and other objects of the present invention, the container and retractable support frame arrangement comprises a container, and a retractable support frame structure mounted in the container and adapted to hold a camera and to support the container above a floor or ground surface. The retractable support frame structure comprises a plurality of sleeves arranged in parallel, positioning means adapted to secure the sleeves to the container, a camera platform provided above the sleeves for holding a camera, and a plurality of extension foot members respectively mounted in the sleeves and movable in and out of the sleeves and the bottom side of the container between an extended position and a retracted position.

### BRIEF DESCRIPTION OF THE DRAWINGS

FIG. 1 is a perspective view of a container and retractable support frame structure arrangement according to the present invention.

FIG. 2 illustrates a status of use of the embodiment shown in FIG. 1.

FIG. 3A illustrates an alternate form of the positioning members according to the present invention.

FIG. 3B illustrates another alternate form of the positioning members according to the present invention.

FIG. 3C illustrates still another alternate form of the positioning members according to the present invention.

FIG. 3D illustrates still another alternate form of the positioning members according to the present invention.

FIG. 4 is a perspective view of an alternate form of the container and retractable support frame structure arrangement according to a second embodiment of the present invention.

FIG. 5 is a perspective view of another alternate form of the container and retractable support frame structure arrangement according to a third embodiment of the present invention.

FIG. 6 is a perspective view of still another alternate form of the container and retractable support frame structure arrangement according to a fourth embodiment of the present invention.

FIG. 7 is a perspective view of still another alternate form of the container and retractable support frame structure arrangement according to a fourth embodiment of the present invention.

### DETAILED DESCRIPTION OF THE INVENTION

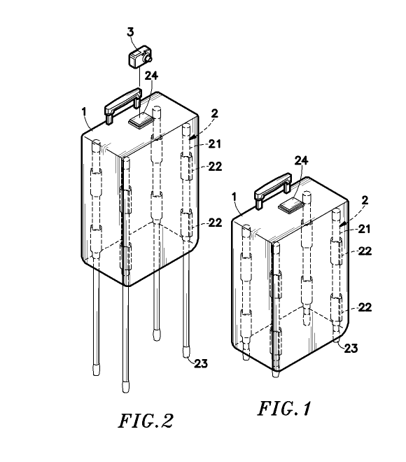

Referring to FIGS. 1 and 2, a retractable support frame structure 2 is installed in a container 1. The retractable support frame structure 2 comprises a plurality of positioning members 22 respectively fastened to the inside walls of the container 1 around the corners, and a plurality of sleeves 21 respectively fastened to the positioning members 22, a plurality of extension foot members 23 respectively mounted in the sleeves 21, and a camera platform 24 provided at a top side above the sleeves 21 for holding a camera 3. The extension foot members 23 can be respectively moved out of the sleeves 21 and locked in the extended position to support the container 1 above a floor or a ground surface. The extension foot member 23 can be fastened to the associating sleeve 21 through a screw joint so that the extension foot member 23 can be rotated into or out of the associating sleeve 21. Alternatively, spring retainer or like means that is commonly used in a retractable handle for travel bag can be used to lock each extension foot member 23 to the associating sleeve 21. Further, the camera platform 24 can be fastened to the container 1 by hook and loop materials, rivet, screw means, or any of a variety of joints. After each use and after remove of the camera 3 from the camera platform 24, the extension foot members 23 are retracted inside the respective sleeves 21. As an alternative form of the present invention, the positioning members 22 can be provided on the outside walls of the container 1.

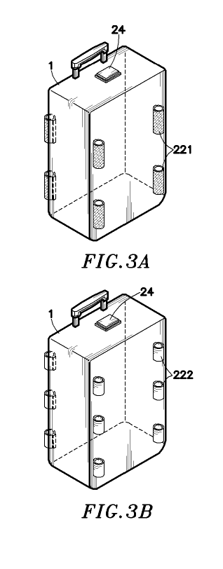

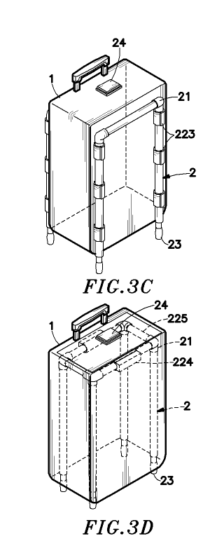

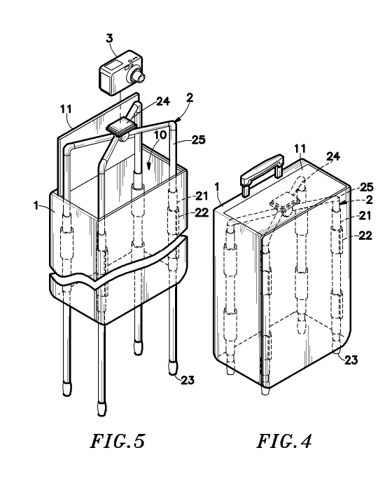

Referring to FIG. 3A and FIG. 1 again, the positioning members 22 can be formed of hook and loop materials 221, and arranged at different elevations in the corners inside the container 1. By means of hook and loop materials 221, the sleeves 21 with the associating extension foot members 23 are temporarily fastened to the inside of the container 1 in the corners.

Referring to FIG. 3B and FIG. 1 again, the positioning members 22 each can be comprised of three retainer rings 222 fastened to the container 1 in one corner and arranged at different elevations. By means of the retainer rings 222, the sleeves 21 with the associating extension foot members 23 are temporarily fastened to the inside of the container 1 in the corners.

Referring to FIG. 3C and FIG. 1 again, the positioning members 22 each can be comprised of three clamps 223 fastened to the container 1 in one corner and arranged at different elevations. By means of the clamps 223, the sleeves 21 with the associating extension foot members 23 are temporarily fastened to the inside of the container 1 in the corners.

Referring to FIG. 3D and FIG. 1 again, the retractable support frame structure 2 can be made comprising a plurality of sleeves 21 vertically arranged in parallel in the four corners of the container 1, a plurality of an extension foot members 23 respectively mounted in the sleeves 21 and movable in and out of the sleeves 21 and the bottom side of the container 1, a plurality of connecting rods 225 horizontally arranged inside the container 1 at the top and respectively connected between each two sleeves 21, and hook and loop materials 224 adapted to secure the connecting rods 225 to the inside walls of the container 1. Retaining rings or clamps may be used to substitute the hook and loop materials 224.

As indicated above, the invention uses positioning members 22 to secure sleeves 21 firmly inside a container 1, enabling extension foot members 23 to be moved in and out of the sleeves 21 and the container 1 between the operative position where the extension foot members 23 support the container 1 above a floor or ground surface stably, and the non-operative position where the extension food members 23 are retracted in the sleeves 21.

As indicated above, the aforesaid positioning members 22 can be formed of hook and loop materials, retaining rings, or clamps. However, the aforesaid embodiments are examples for understanding of the spirits of the present invention. Other suitable positioning means may be used as a substitute. Further, the container 1 can be a travel bag, a baggage, a luggage, a suitcase, or a backpack.

According to the embodiment shown in FIGS. 4 and 5, the container 1 defines therein a storage chamber 10, having a hinged top cover 11. The retractable support frame structure 2 is mounted in the storage chamber 10 inside the container 1, comprising a plurality of sleeves 21 vertically arranged in parallel in the four corners inside the storage chamber 10, a plurality of positioning members 22 that secure the sleeves 21 to the inside walls of the container 1, a plurality of extension foot members 23 respectively mounted in the sleeves 21 and axially movable in and out of the sleeves 21 and the bottom side of the container 1, a camera platform 24 equally spaced from the sleeves 21, and a plurality of top extension bars 25 respectively coupled between the sleeves 21 and the camera platform 24. According to this embodiment, the top extension bars 25 are angled bars, each having one end axially slidably mounted in the sleeve 21 and the other end fixedly connected to the camera platform 24. When in use, the hinged top cover 11 is opened, and then the top extension bars 25 are extended out of the sleeves 21 to lift the camera platform 24 to the desired elevation, and then the camera 3 is fastened to the camera platform 24 for taking pictures (or video images). Further, spring retainer or like means that is commonly used in a retractable handle for travel bag can be used to lock each top extension bar 25 to the associating sleeve 21.

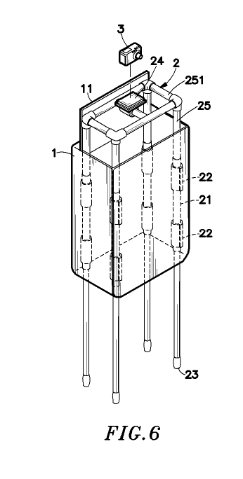

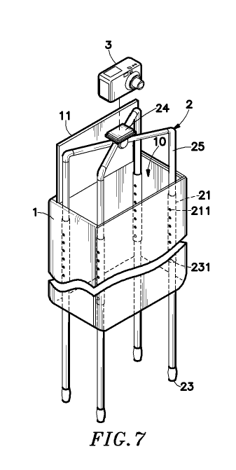

According to the embodiment shown in FIG. 6, the top extension bars 25 are straight bars respectively slidably inserted into the sleeves 21, and a top rack 251 is fastened to the top end of each of the top extension bars 25 to hold the camera platform 24 at the top center.

The embodiment shown in FIG. 7 is substantially similar to the embodiment shown in FIG. 5 with the exception that each sleeve 21 has a plurality of vertically spaced retaining holes 211, and each extension foot member 23 has a spring-supported retainer 231 for selectively engaging one of the retaining holes 211 of the associating sleeve 21 to lock the respective extension foot member 23 to the associating sleeve 21 at the desired elevation.

As indicated above, the invention provides a container and retractable support frame structure arrangement, which has the following advantages.

1. The user needs not to carry a tripod and can use the container directly to support a camera on a floor or ground surface for taking pictures (or video images).

2. The retractable support frame structure can be adjusted to the desired height. Further, because the retractable support frame structure forms a part of the container, the retractable support frame structure can conveniently be carried with one's luggage to any desired place.

3. The retractable support frame structure can be adjusted to the desired height to support the container above the floor or ground, preventing direct contact of the container with dirty substances or water on the floor or ground.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A container and retractable support frame structure arrangement comprising a container, and a retractable support frame structure mounted in said container and adapted to hold a camera and to support said container above a floor surface, said retractable support frame structure comprising a plurality of sleeves arranged in parallel, positioning means adapted to secure said sleeves to said container, a camera platform provided above said sleeves for holding a camera, and a plurality of extension foot members respectively mounted in said sleeves and movable in and out of said sleeves and a bottom side of said container between an extended position and a retracted position.

2. The container and retractable support frame structure arrangement as claimed in claim 1, wherein said extension foot members are respectively fastened to said sleeves through a respective screw joint.

3. The container and retractable support frame structure arrangement as claimed in claim 1, wherein said retractable support frame structure comprises means adapted to lock said extension foot members to said sleeves in one of said extended position and said retracted position.

4. The container and retractable support frame structure arrangement as claimed in claim 1, wherein said positioning means is comprised of hook and loop materials.

5. The container and retractable support frame structure arrangement as claimed in claim 1, wherein said positioning means comprises a plurality of retainer rings respectively fixedly mounted in corners of said container at different elevations for securing said sleeves to said container in a parallel manner.

6. The container and retractable support frame structure arrangement as claimed in claim 1, wherein said positioning means comprises a plurality of clamps respectively fixedly mounted in corners of said container at different elevations for securing said sleeves to said container in a parallel manner.

7. The container and retractable support frame structure arrangement as claimed in claim 1, wherein said positioning means are provided on the outside of said container to hold said sleeves outside said container.

8. The container and retractable support frame structure arrangement as claimed in claim 1, wherein said camera platform is fastened to a top side of said container with hook and loop materials.

9. The container and retractable support frame structure arrangement as claimed in claim 1, wherein said camera platform is fastened to a top side of said container by a screw joint.

10. The container and retractable support frame structure arrangement as claimed in claim 1, wherein said camera platform is riveted to a top side of said container.

11. The container and retractable support frame structure arrangement as claimed in claim 1, wherein said retractable support frame structure further comprises a plurality of angled extension bars respectively coupled between said sleeves and said camera platform, said angled extension bars each having a first end slidably mounted in one of said sleeves opposite to the corresponding extension foot member and a second end fixedly connected to said camera platform.

12. The container and retractable support frame structure arrangement as claimed in claim 1, wherein said retractable support frame structure further comprises a plurality of straight extension bars respectively slidably mounted in said sleeves, a top rack fixedly fastened to a top end of each of said straight extension bars and holding said camera platform at a top center thereof.

13. The container and retractable support frame structure arrangement as claimed in claim 12, wherein said straight extension bars are respectively fastened to said sleeves through a respective screwjoint.

14. The container and retractable support frame structure arrangement as claimed in claim 12, wherein said retractable support frame structure comprises means adapted to lock said straight extension bars to said sleeves.
